(19) United States
(12) Patent Application Publication
(10) Pub. No.: US 2007/0282684 A1
(43) Pub. Date: Dec. 6, 2007

(54) System and Method for Determining Affinity Profiles for Research, Marketing, and Recommendation Systems

(76) Inventors: Steven H. Prosser, Mercer Island, WA (US); Gary Cliff Martin, Edinburgh (GB); Marius Octavian Buibas, Escondido, CA (US)

Correspondence Address: SEMIONIX, INC., 3853 82ND AVE. SE, MERCER ISLAND, WA, 98040, US

(21) Appl. No.: 11/745,322

(22) Filed: May 7, 2007

Related U.S. Application Data
(60) Provisional application No. 60/747,135, filed on May 12, 2006.
(60) Provisional application No. 60/864,393, filed on Nov. 4, 2006.

(51) Int. Cl. G06Q 30/00

(52) U.S. Cl. 705/14

(57) ABSTRACT

The present invention relates to systems and methods enabling the identification and/or application of user affinities in an automated and highly effective manner. A method of the present invention includes enabling a user to build or evaluate a portion of or an entire personal expression. As this is done, an analytical process obtains knowledge about affinities for the user. This knowledge can be used for any number of purposes such as recommending products, generating meaningful content, or optimizing product packaging, to name a few.

### RELATED APPLICATIONS

This non-provisional patent application claims priority to U.S. Provisional Application Ser. No. 60/747,135, Entitled “System and Method for Determining Affinity Profiles for Research, Marketing, and Recommendations Systems”, by Prosser et al., filed on May 12, 2006, incorporated herein by reference under the benefit of U.S.C. 119(e). This non-provisional patent application also claims priority to U.S. Provisional Application Ser. No. 60/864,393, Entitled “System and Method for Determining Affinity Profiles for Research, Marketing, and Recommendations Systems”, by Prosser et al., filed on Nov. 4, 2006, incorporated herein by reference under the benefit of U.S.C. 119(e).

### FIELD OF THE INVENTION

The present invention relates to systems and methods enabling the identification and application of user affinities in an automated and highly effective manner.

### BACKGROUND OF THE INVENTION

Understanding meanings and predicting user responses is a highly challenging process that often ends in disappointing results. One reason marketing communications can fail is a lack of insight into the semiotics of and responses prompted by advertisements, packaging, or other marketing content. One reason recommendation systems can fail is the over reliance on techniques such as collaborative filtering technologies which cannot classify users apart from their purchase or web site visitation histories. The issues affecting the prediction and classification of consumer response are driven by shortcomings in current processes for analyzing user affinities.

One way user affinity insights can be obtained is through focus groups, surveys and interviews. These can be helpful in characterizing the consumer overall response to products, packaging, advertisements, and recommendations. However, these processes do not adequately account for how the component elements comprising a finished marketing communication affect users. For example, a favorably received advertisement may be composed of text and an image. Overall response to the advertisement, however, may not be fully optimized because the response to the image used is not fully consistent with the message in the text. These issues become increasingly important and difficult as companies strive to achieve greater personalization in their marketing communications.

Product or search recommendation systems often make recommendations based on previous purchases or searches. Because of this, the scope of these systems is limited to historic user activities. Other factors affecting user response to products are not directly evaluated. For example, if a user has only bought comedic movies, other movies recommended will most likely be other comedies. If the user demonstrates a strong emotional response to artistic expressions that juxtapose the themes of heroism and tragedy, the recommendation system will not account for this.

There is a need to obtain deeper insight into what causes consumer affinities based on the meanings and responses to marketing content, and products. These deeper insights cannot be readily obtained from the current, conventional methods of analysis.

### BRIEF DESCRIPTION OF THE DRAWINGS

FIG. 1 is a process flow chart representation of a process for generating user affinity knowledge.

FIG. 2 is a block diagram representation of an exemplary ecosystem that enables the present invention.

FIG. 3 is a schematic representation of a user system.

FIG. 4 is a schematic representation of a user interface utilized by the present invention.

FIG. 5 is a graphical representation of a portion of the user interface referred to as a personal expression builder or template.

FIG. 6 is a representation of the process used for building a personal expression.

FIG. 7 is a representation of information associated with a single object utilized during the creation of a personal expression.

FIG. 8 is a representation of actions performed on an object.

FIG. 9 is a graphical representation of a personal expression viewer.

FIG. 10 is a graphical representation of an interface for capturing user feedback regarding personal expressions.

FIG. 11 is a graphical representation of a portion of the user interface utilized when a user assigns a relative rank to previously created personal expressions.

FIG. 12 is a schematic representation of an analytic subsystem that is a portion of a user affinity knowledge system.

FIG. 13 is a flow chart representation of an exemplary association analysis software module used to identify associative links between different objects for groups of users.

FIG. 14 is a flow chart representation of an object frequencies software module used to analyze affinity for certain objects.

FIG. 15 is a flow chart representation of a cluster mapping software module used to analyze associative links between different objects for groups of users.

FIG. 16 is a flow chart representation of a sub-cluster mapping software module used to identify groups of users based upon their affinities.

FIG. 17 is a flow chart representation of a Bayesian mapping software module used to analyze the tendency of selection of one object to follow another.

FIG. 18 is a flow chart representation of a personal expression rank order software module used to determine affinities for previously created personal expressions.

FIG. 19 is a flow chart representation of an object end state rank order software module used to determine what objects were most crucial in determining which personal expressions were preferred by users.

FIGS. 20a-d depicts examples of user affinity knowledge that can be obtained from the present invention.

FIG. 21 is a process flow representation of a method whereby a user affinity profile is obtained from media preference information.

FIG. 22 is a process flow representation of a method whereby a media preference is utilized for the modification or optimization of marketing content based on an affinity profile.

FIG. 23 is a process flow representation of a method whereby a use or selection of objects, or a selection of rankings of finished expressions is used to assign an affinity profile.

FIG. 24 is a process flow representation of a method of correlating a cluster of users having a certain affinity profile with a cluster of users having another characteristic such as a demographic profile, a behavioral characteristic, or a preference.

FIG. 25 is a process flow representation of a way of dynamically modifying or optimizing marketing content based upon user selection of objects identifying an affinity profile.

FIG. 26 is a process flow representation of a way of dynamically modifying or optimizing marketing content based upon an existing user affinity profile.

FIGS. 27A and 27B are process flow representations of methods to enhance a recommendation system using affinity profiles.

FIG. 28A is a schematic representation of a partially completed personal expression with some alternative objects that may be selected to complete the expression.

FIG. 28B is a flow chart representation of a method wherein a user completes a personal expression.

FIG. 29A depicts a vector representation of an affinity profile.

FIG. 29B depicts a matrix representation of an affinity profile.

FIG. 29C depicts a way of relating a matrix representation of an affinity profile to a map representation of an affinity profile.

FIGS. 30A and 30B depict a composite representation of an affinity profile.

FIGS. 31A and 31B depict a system of the present invention.

FIG. 32 is a process flow diagram representation of the operation of a query response system.

FIGS. 33 A and 33B is a flow chart representation of the operation of a matchmaking system.

FIG. 34 is a flow chart representation of an optimization of a query response.

### DETAILED DESCRIPTION OF THE PREFERRED EMBODIMENTS

The present invention is a method for generating and applying knowledge about affinities expressed by a user, or groups or clusters of users. An affinity is a response that is affected by personal meanings and or emotions elicited from users. In the context of the present invention, a user is any person for which the goal is to understand affinities. A user can be a consumer and the goal can be for the purpose of understanding consumer affinities for purposes such as enhancing product, marketing communications, or recommendations. A user can alternatively be a business buyer and the goal can be to understand what aspects of a product or service are important to such a buyer. Other examples of users are possible with the one thing in common being a need or desire to understand their affinities.

An affinity is anything that has an affect upon the user where the affect is based on a special semiotic, or emotive for the user. An example of an affinity is an image for which the user has a strong positive association. Such an image might be a picture of a family playing, a mountain peak, a splash of water, etc. An affinity may be affected by the context in which a user is experiencing an object. For example, an image of a sleeping baby may have different affinities for a user when presented in unrelated contexts such as buying a car and buying health care insurance. Affinities may not be the same for all users even within the same context. Continuing with the example, the positive response to the image of the sleeping baby in a car advertisement may apply to married individuals, but not to single retirees with no children.

The concept of an affinity can be broader than an individual object, and can include concepts, attributes, appearances, experiences, objects, or combinations of objects that prompt specific meanings and/or emotive responses from users. It can also include sets or groups of objects that create an expression. For example, a series of objects may be grouped and positioned by a user in a manner that expresses an idea or emotion that is personally relevant, or emotionally meaningful to the user. Once completed, this personal expression becomes an object that can be used to measure affinities of other users either for the objects comprising the expression, or for the component and overall ideas, meanings, or emotions expressed by the combination of objects.

The present invention concerns a way of obtaining, and applying affinity knowledge from the way in which users select and associate objects or combinations of objects in an effort to create a personally relevant expression. In the context of the present invention, an object can include any one of the following:
A word, symbol, numerical or text character
A moving or still image
A video or audio/video clip
A sound, musical note, or other audio clip
A background image or graphic
Pre-defined groups of individual objects

A result of a method of the present invention is to obtain an “affinity profile”. This system of affinity profiles is built by prompting and analyzing user semiotic and emotive responses. An affinity profile is obtained by finding patterns that reveal for a user or for a group of users the semiotics of and/or emotional responses to objects and/or expressions composed of objects. As such, affinity profiles can be used to proactively discern and apply abstract elements such as meaning, and emotional response to marketing communications and recommendation systems.

Affinity profiles for a group may be found by first grouping users based on identifiable characteristics, and then analyzing patterns for the group. Group affinities may also be found by analyzing how semiotic and/or emotive patterns create distinct clusters of users within a larger group of users without any a priori assignment of users into a group.

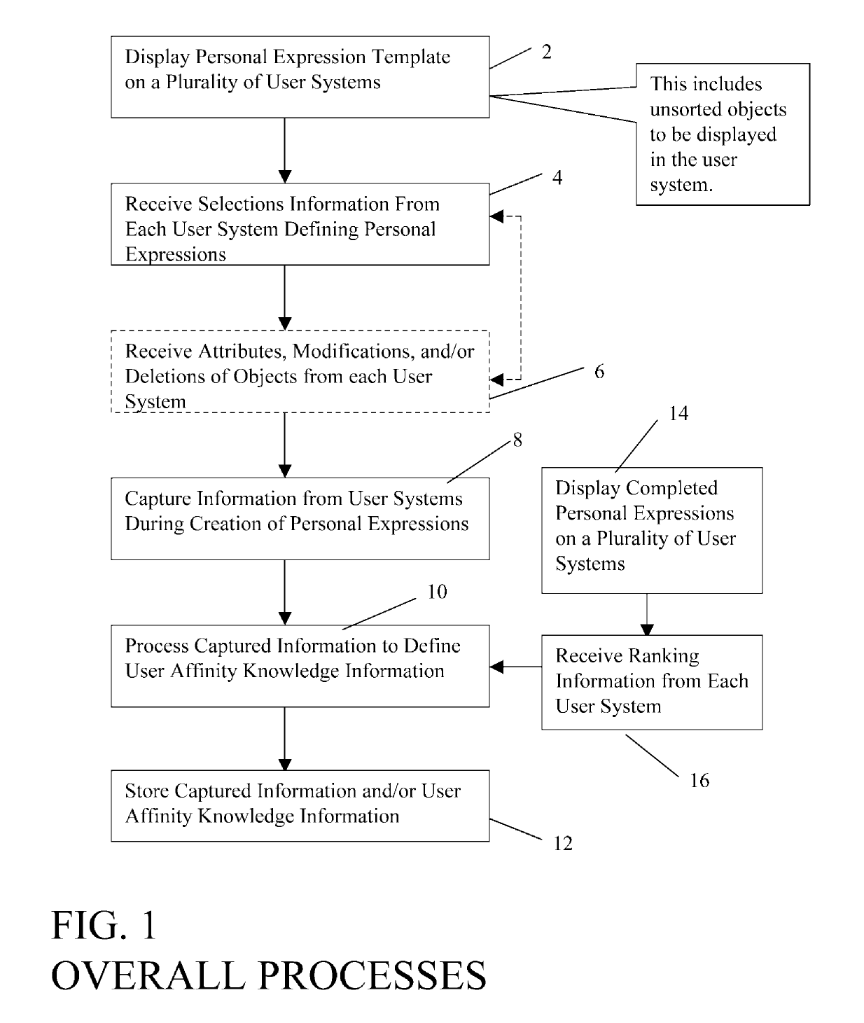

A method of the present invention is depicted in process flow form in FIG. 1. As will become apparent, FIG. 1 actually depicts two alternative processes. In an exemplary embodiment, the method of FIG. 1 involves a plurality of individual users that each have a user system such as a personal computer. Each user system is coupled (for example by the internet) to a user affinity knowledge system that is used to capture information from user systems, and to process the information to generate the knowledge about user affinities (that may includes user affinity profiles assigned to clusters of users).

According to 2, a personal expression template is displayed on each user system. The personal expression template is a software tool that can be used by each user to create a personal expression. In an exemplary embodiment, the personal expression template displays a number of user selectable objects.

According to 4, the user utilizes the template to create a personal expression. In an exemplary embodiment, creating a personal expression includes selecting from among and configuring the user selectable objects to build a personal expression. A personal expression is, for example, a poem that reflects affinities of the user.

According to 6 (preferred embodiment) the user deletes, modifies, or changes attributes of objects. This would be a normal part of a creative process wherein an original “plan” for a personal expression changes as it is being created. A “user session” is defined during the creation of the personal expression according to elements 2, 4 and optionally 6.

According to 8 the knowledge system captures information from the user systems during the process of creating the personal expressions. According to 10 this information is processed to define affinity knowledge information.

Note that the processing as in 10 may be “real time” or it may occur after a number of users have created personal expressions. According to 12 the knowledge and/or information is stored by the user affinity knowledge system.

Once a number of personal expressions have been created another process may take place. According to 14 a plurality of personal expressions are displayed on a number of user systems. According to 16 each user ranks the personal expressions. The ranking information is then captured and processed to define affinity knowledge.

Examples of such knowledge might be any of the following:
Objects having Strongest Affinity or that are Most Often Selected
Percentage of User Utilizing Each Object in a Personal Expression
Personal Expressions having Strongest Affinity or Ranked Highest
Objects Responsible for Highest Ranked Personal Expressions
Combinations of Objects having Strongest Affinity
Average Time Duration an Object Appears During User Sessions
Average Time Duration Sets of Objects Appear During User Sessions
Objects Typically Selected First or Last During User Sessions
Affinity Profiles That Define the Above for Clusters of Users

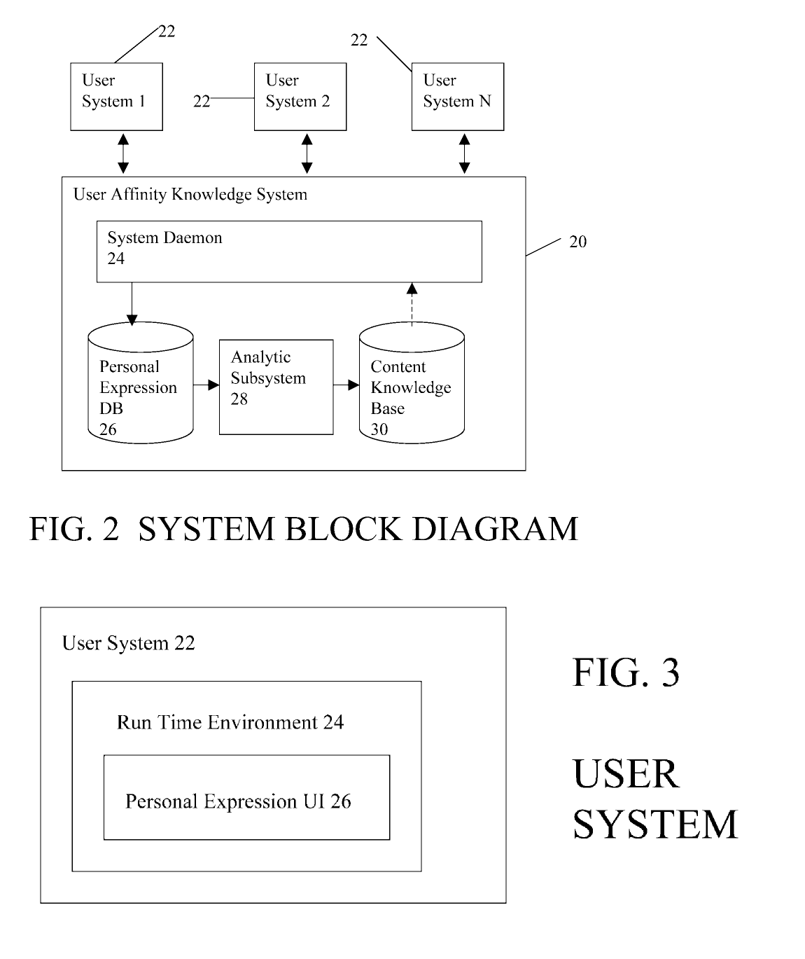

An exemplary ecosystem that enables the present invention is depicted in block diagram in FIG. 2. The ecosystem includes a user affinity knowledge system 20 that is in communication with or coupled to a plurality of user systems 22. Coupling knowledge system 20 and user systems 22 may be a network such as the internet (not shown). A user system 22 can be a personal computer, a cellular telephone, a PDA, a laptop or notebook computer, or any device that can provide functions required by the present invention.

Exemplary knowledge system 20 includes various components such as a system daemon 24, a personal expression database 26, an analytic subsystem 28, and a content knowledge base 30. Database 26 and knowledge base 30 can also exist as one database.

System daemon 24 performs administrative functions in system 20. Personal expression database 26 captures information during the creation or evaluation of personal expression as discussed with respect to element 8 of FIG. 1.

Analytic subsystem 28 is a software module configured to process (according to element 10 of FIG. 1) or analyze information captured when personal expressions are created and/or evaluated. The processing or analysis performed by analytic subsystem 28 results in user affinity knowledge that is stored in knowledge base 30.

User system 22 is further depicted in FIG. 3. Within user system 22 is a run time environment 24 such as an AJAX or Adobe/Macromedia Flash environment within a web browser or other environments such as widget, or kiosk interface. Within the run time environment 24 is a personal expression user interface 26 that is utilized for creating, viewing, and ranking personal expressions.

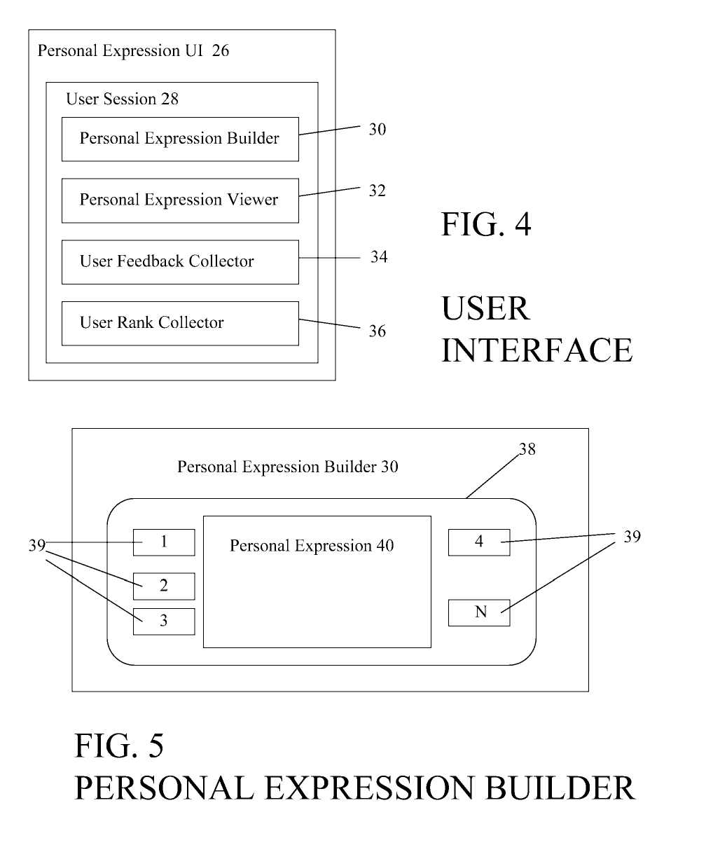

FIG. 4 depicts the personal expression user interface 26. Within the personal expression user interface a user session 28 is defined. Defined within a user session 28 is alternatively or in combination a personal expression builder or template 30, a personal expression viewer 32, a user feedback collector 34, and a user rank collector 36. Depending on the user system 22 elements 32-36 can be displayed at the same time or during separate sessions.

Personal expression builder 30 is the builder or template that provides tools enabling a user to build a personal expression. Personal expression viewer 32 allows a user to view a personal expression. User feedback collector 34 enables a user to view a personal expression while entering qualitative or quantitative feedback such as comments or like/dislike scale measures that are received by user affinity knowledge system 20. User rank collector 36 enables a user to rank or indicate a relative preference for previously created personal expressions.

FIG. 5 depicts a personal expression builder or template 30. Template 30 includes a view 38 within which a personal expression 40 is to be constructed by selecting and placing objects 39 into position within personal expression 40. Personal expression 40 as depicted in FIG. 5 does not yet contain any objects except perhaps an already selected background (that may be the first object selected). As a note, some objects such as sounds or music may not have a “position” in the geometric sense.

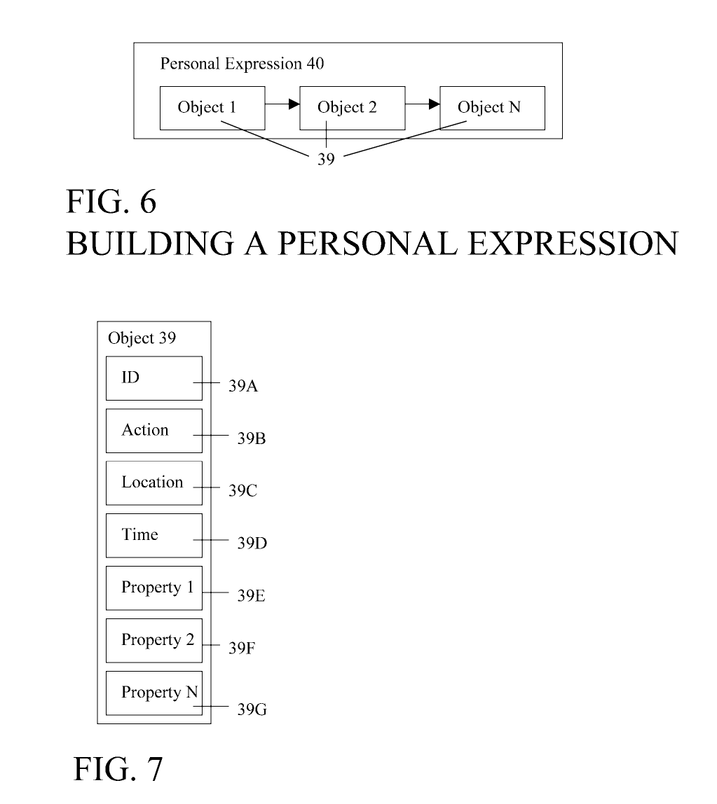

FIG. 6 depicts the construction of a personal expression 40 by selecting and placing objects 39 into a region of the view 38 to be covered by personal expression 40. In a preferred embodiment, personal expression 40 is constructed by “dragging and dropping” objects 39 into personal expression 40. Although FIG. 6 only depicts a few objects being selected for personal expression 40 it is to be understood that any number of objects 39 can be selected for a personal expression 40 and that personal expressions 40 may vary widely in complexity.

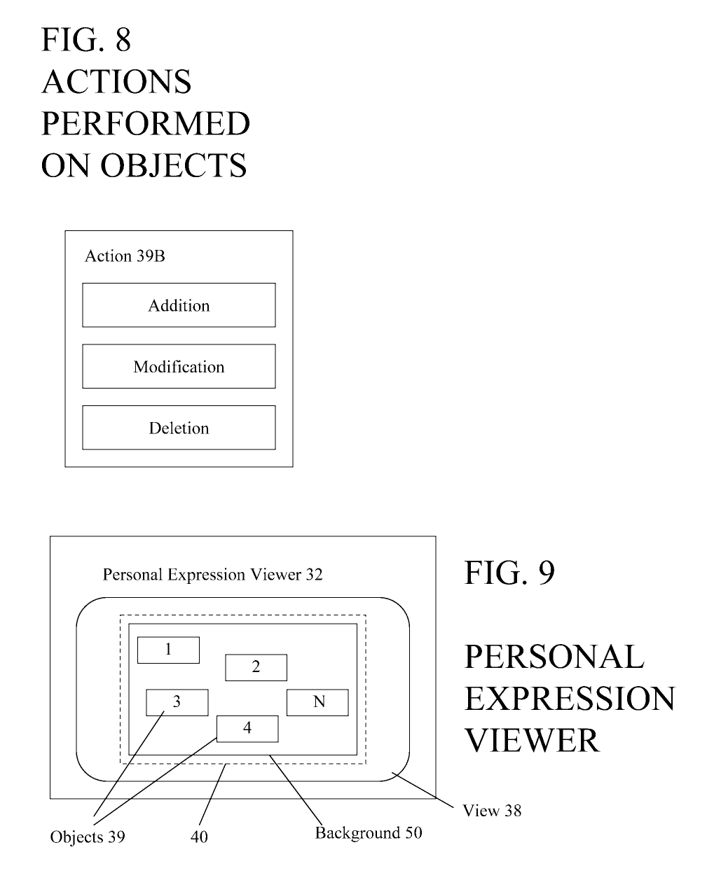

FIGS. 7 and 8 depict information 39A-G defining the status an object 39 during and after the creation of a personal expression. Each object has an ID 39A (identification) associated therewith. An action 39B can include an addition, modification or deletion.

The location 39C is indicative of where an object is placed upon the personal expression 40 when it is selected. As discussed earlier, some elements such as music or sound clips may not have a location. Time 39D is indicative of a time of addition (and deletion if applicable) and any other operations performed on object 39. Properties (39E-G) are other aspects and/or attributes of object 39. Any or all of information depicted by elements 39A-G can be collected for each object that is placed in personal expression 40.

We can refer to the building and ranking of personal expressions as “user sessions”. Information 39A-G is obtained during each user session.

FIG. 9 depicts personal expression viewer 32 (and is similar in appearance of the personal expression builder during a user session of building a personal expression 40) after a personal expression 40 has been at least partially defined in view 38. Personal expression 40 includes a background 50 and objects 39. Some of the objects included in personal expression 40 can be sounds or music.

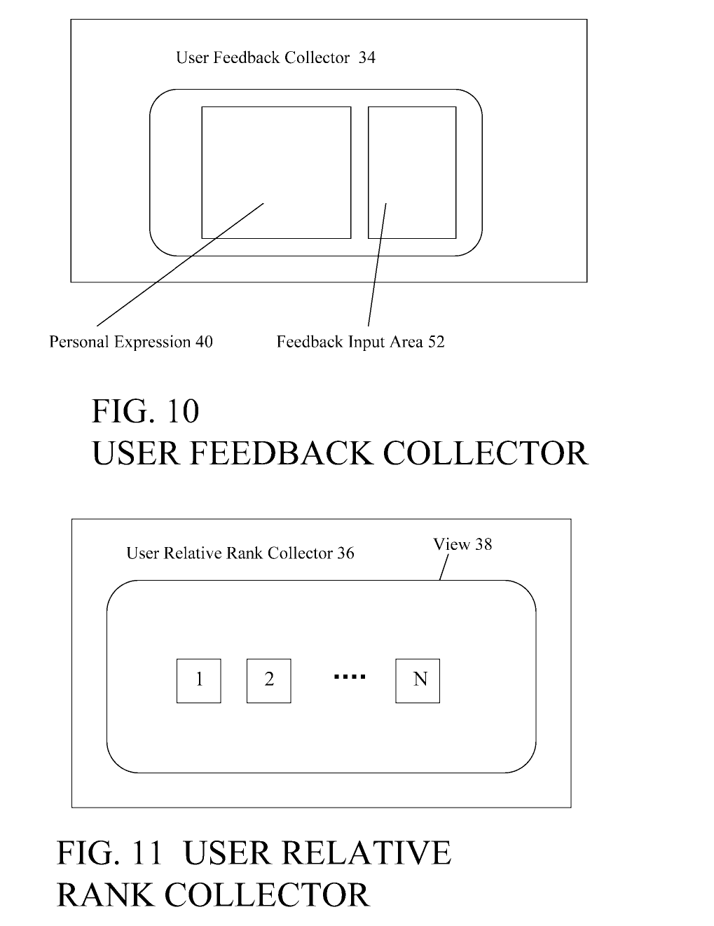

FIG. 10 depicts user feedback collector 34 including personal expression 40 and feedback input collector 52. A user may view a personal expression 40 and provide qualitative and/or quantitative input using collector 52. Alternatively element 52 may refer to an audio input such that a user may verbally comment on a personal expression 40.

FIG. 11 depicts user rank collector 36. Within view 38 the user ranks personal expressions relative to all expressions within view 38 such as expression 1 being a favorite, expression 2 being a next favorite, and so on. Ranking personal expressions is discussed with respect to elements 14 and 16 of FIG. 1.

When a user builds a personal expression as discussed with respect to FIGS. 1-11 the user affinity knowledge system captures information. After or during this process, the analytic subsystem 28 processes the information and in so doing generates user affinity knowledge. This knowledge is based on processing the data captured during creation of personal expressions. Examples of the type of user affinity knowledge generated are the following:
Selection of or affinity to Objects: What objects are preferred. A simple example is a rank order from the most commonly selected object to the least commonly selected. A second example would be the percentage of users that utilized each object as a part of a personal expression. A third example would be the average amount of time each object was part of a personal expression averaged over the user sessions.
Association of Objects: The strength of association between objects. One metric might be what pairs or sets of objects appeared most frequently together in personal expressions. Another metric might be the average duration of time that each pair or set of objects appeared together in a personal expression. Another metric might be the relative proximity between two objects or two sets of objects in a personal expression.
Bayesian Association of Objects: The tendency of the selection of one object or set of objects to precede the selection of a second.
User Clustering: Looking for points of concentration of users such as selection of individual objects, combinations of objects, associations of objects, ranking of personal expressions, etc. Cluster analysis techniques can be utilized for this purpose. An example of cluster analysis is the K-means cluster analysis. The result of cluster analysis may be one or more clusters of users that each have a user affinity profile associated therewith.
Other Methods: Maximum entropy modeling is a form of statistical modeling of a random process. Graphical methods and graph theory can also be utilized. These are but a few of the possible analysis tools that can be utilized in analytic subsystem 28.

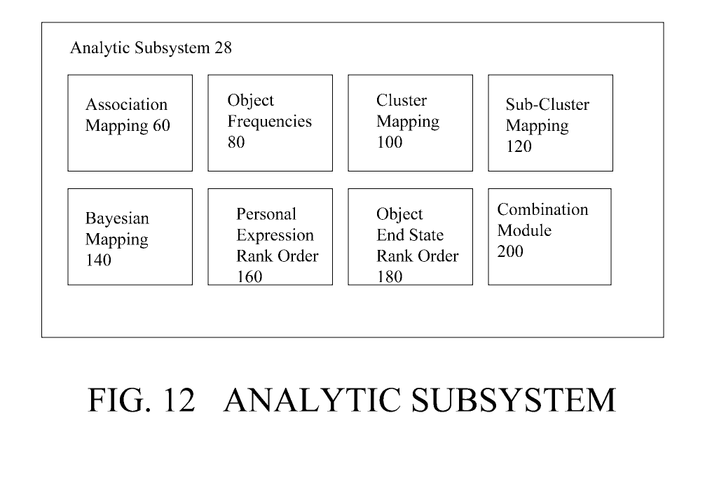

An exemplary embodiment of analytic subsystem 28 is depicted with respect to FIG. 12. When a number of users build personal expressions, information is collected based upon their selection, placement, and deletion of objects, and ranking of personal expressions. Analytic subsystem 28 includes a plurality of software modules that process this information to define user affinity knowledge and user affinity profiles. Exemplary software modules include objects 60, 80, 100, 120, 140, 160, 180 and 200 of FIG. 12.

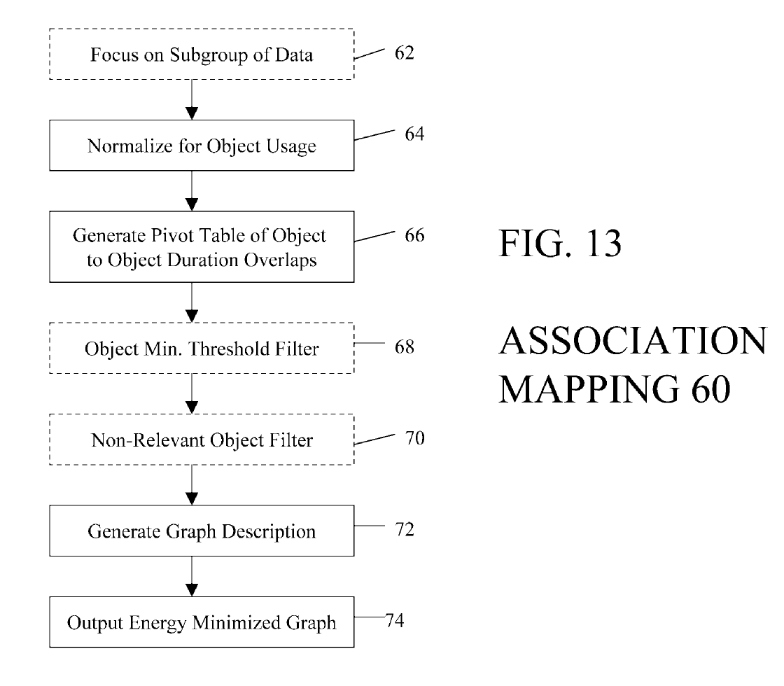

FIG. 13 is a flow chart representation of an exemplary embodiment of association-mapping module 60. The use of dashed boxes in flow chart or process flow representations indicates optional processes or steps although some boxes with solid lines are also optional. The association-mapping module 60 obtains knowledge about user affinities using the associations between pairs or sets of objects. According to this embodiment, this is related to durations of time (within the user session) during which pairs or sets of objects were all positioned within a personal expression.

According to 62, module 60 optionally selects a subset of the users for which to process the information. For example, this may be performed in the case in which only certain demographics of users are to be studied. Use of a subset of users is optional.

According to 64, data normalization takes place. For example, some users may have built multiple personal expressions or may take much longer than others to build personal expressions. Both of these types of users may tend to skew (or influence in excess) the data from the group. Data normalization according to 64 reduces the tendency to skew the data.

According to 66, a pivot table (or other data analysis tool) is generated for each pair or set of different objects containing information on durations of their overlaps. For each pair or set of objects—object X and object Y—the duration of the overlap equals the duration of time during which both object X and object Y were present on the personal expression during a user session.

According to 68, data from individual user selections or individual users is eliminated when it falls below a certain threshold. In an exemplary embodiment rarely or briefly used objects may be omitted due to low statistical relevance. The resultant data may be eliminated from the analysis. Use of a threshold is optional.

According to 70, non-relevant objects are eliminated from the analysis. For example, if objects include word objects, then words like “and”, “or”, “the”, etc. may be eliminated since they are not part of the content being studied.

According to 72 a graph description is generated from the pivot table or data set. A graph description is a translation of the information in the Pivot Table into a format that can be used to generate a graph or by other analytic modules. A graph description may not be required.

According to 74 an energy-minimized map is generated that depicts the results. An energy minimized map is a two dimensional representation of the objects that makes it easy to visualize the results. In one embodiment groups of objects with the strongest associations will tend to be near the center of the map with smaller distances between them. Objects that are not strongly associated with others will tend to be in the periphery of the map with greater distances between them.

Energy minimized graphs are produced with standard graph visualization software. They are often used for graphing networks.

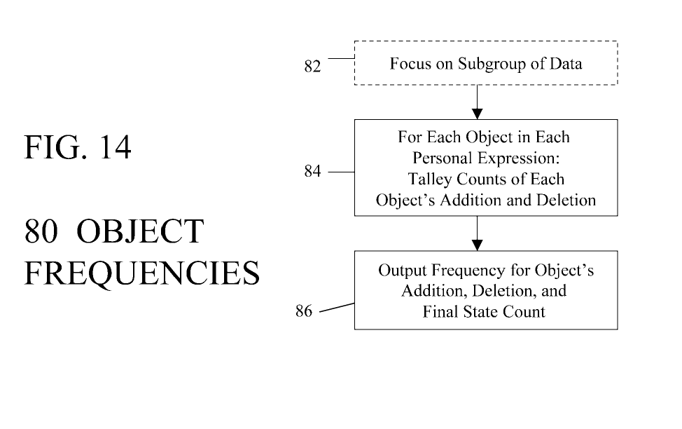

FIG. 14 is an exemplary flow chart representation of an exemplary embodiment of module 80 that generates “object frequency” information. The object frequency correlates with the percentage of users that selected a particular object. This may be normalized for users that created more than one personal expression.

According to 82, module 80 selects a subset of the users for which to process the information. This may be performed in the case in which only certain demographics of users are to be studied, for example. Use of a subset of the users is optional.

According to 84, for each object in each personal expression a count or tally of addition and deletion takes place for each object. For each object this determines (1) how many times has it been selected and (2) how many times it has been deleted.

According to 86 a final tally or average is generated for each object across the data. This provides the average (per user and/or per personal expression) indicative of how many additions, deletions, and final state for each object. Knowledge generated includes:
Average final state for the object (indicative of additions minus deletions). For example, what percentage of the personal expressions contained an object or set of objects when completed.
How often the object was deleted. For example, a high frequency of deletions may indicate a difficulty in associating the object with other objects. It may be a preferred individual object, but not complement other objects.

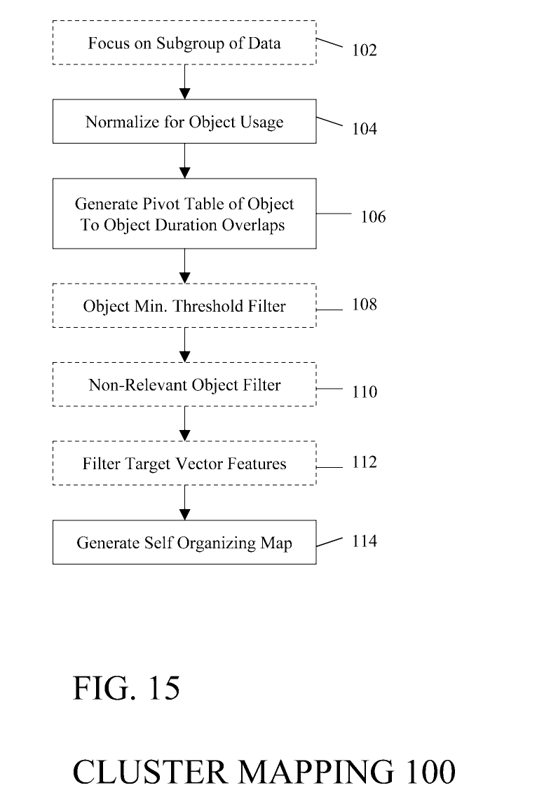

FIG. 15 is an exemplary flow chart representation of “cluster mapping” module 100 that results in generation of Self Organized Maps. This is done to visually show equivalency between personal expression objects. Objects used in similar ways will be clustered together in the self-organized map. Those that are more dissimilar will be spatially separated.

According to 102, module 100 selects a subset of the users for which to process the information. This may be performed in the case in which only certain demographics of users are to be studied, for example. Selecting a subset is optional.

According to 104, data normalization takes place in a manner similar to element 64 of FIG. 13. According to 106, a pivot table (or other data analysis tool) is generated for each pair or set of different objects containing information on durations of their overlaps in a manner similar to element 66 of FIG. 13. Elements 108 and 110 are similar to elements 68 and 70 described with respect to FIG. 13.

According to optional process 112 selected object vector features are removed from this analysis to simplify the analysis. This makes the relationships between objects of high interest more clear.

According to 114 a SOM (self organized map) is generated that depicts object similarity. More similar objects are placed closer together on this map. Stated another way, objects that are used in similar ways tend to be clustered closer together.

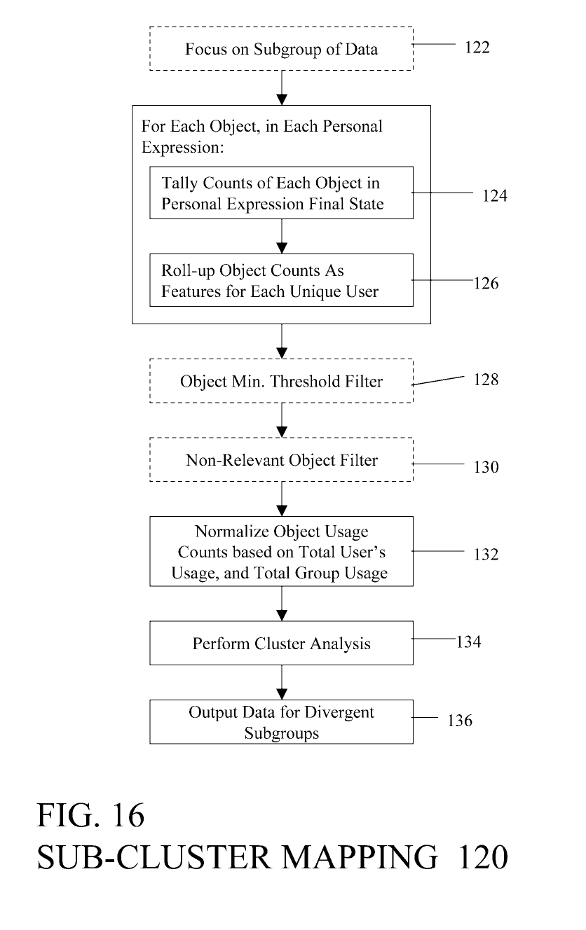

FIG. 16 is an exemplary flow chart representation of “sub-cluster” mapping module 120. Sub-cluster analysis is performed to define groups of users with similar affinity characteristics. Stated another way, the results of this process define sub-clusters of users that share a characteristic affinity profile. The method of flow chart 16 is exemplary in that there are other ways of clustering users according to the present invention.

According to 122, module 120 selects a subset of the users for which to process the information in a manner similar to that discussed with respect to element 62 of FIG. 13. According to 124, the counts of additions and deletions are counted (# additions-# deletions) to determine the final state of each object for each personal expression.

According to 126, the objects used (and counts of each that remain in the final state of each personal expression) for each unique user are determined. The processes performed according to 128 and 130 are similar to elements 68 and 70 discussed with respect to FIG. 13.

According to 132 the object counts are normalized. This can be done in any number of ways. In one embodiment correction is made for a user who has created more than one creative expression.

According to 134 a cluster analysis is performed that would tend to group users according to their selections of objects. There are various known methods of cluster analysis such as K-means clustering.

According to 136 data is output for each separate cluster. This can be done in a tabular manner and/or graphically.

Note the sub-cluster mapping discussed with respect to FIG. 16 is one example of cluster analysis that can be used to define groups or clusters of users having similar affinity profiles. Examples of criteria that can be used to define the affinity profiles are as follows:
Object Preferences or Selections or Affinities
Object to Object Association Affinities or Preferences
Personal Expression Preferences or Affinities
Combinations of the Above

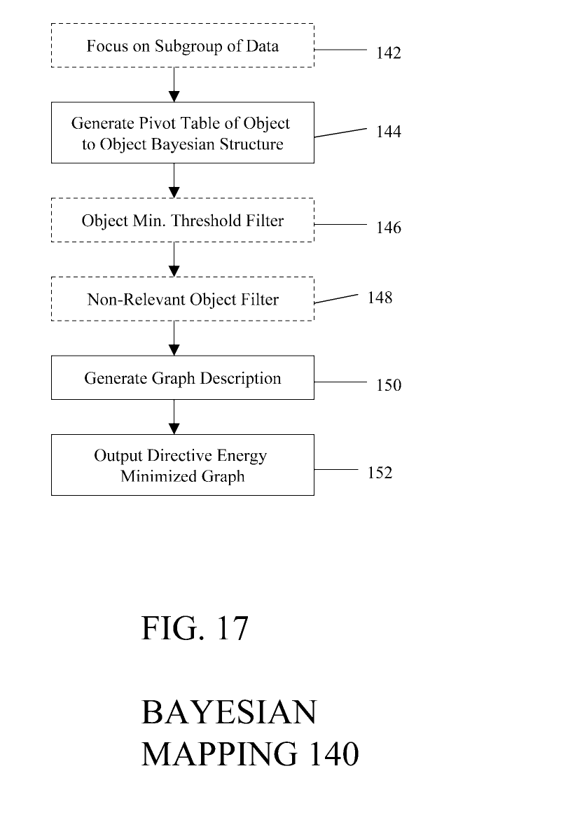

FIG. 17 is an exemplary flow chart representation of a Bayesian analysis module 140. Module 140 analyzes the tendency for the selection of one object to precede another. Stated another way, module 140 generates information related to the order or sequence that objects are selected. According to 142, module 140 selects a subset of the users for which to process the information in a manner similar to that discussed with respect to element 62 of FIG. 13.

According to 144 a pivot table (or other data representation method) is generated containing object-to-object Bayesian structure. This table represents how much the selection of one object or set of objects led to the selection of another.

Elements 146 and 148 are similar to elements 68 and 70 discussed with respect to FIG. 13. According to 150, a graph description is generated. This is a translation of the information in the Pivot Table to a directive depiction that indicates the order of selection—object X→object Y indicates that object X tended to be selected prior to object Y.

According to 152, an energy-minimized graph is generated. This graph includes the directive information in the form of arrows, and would tend to have stronger objects and object associations toward the center.

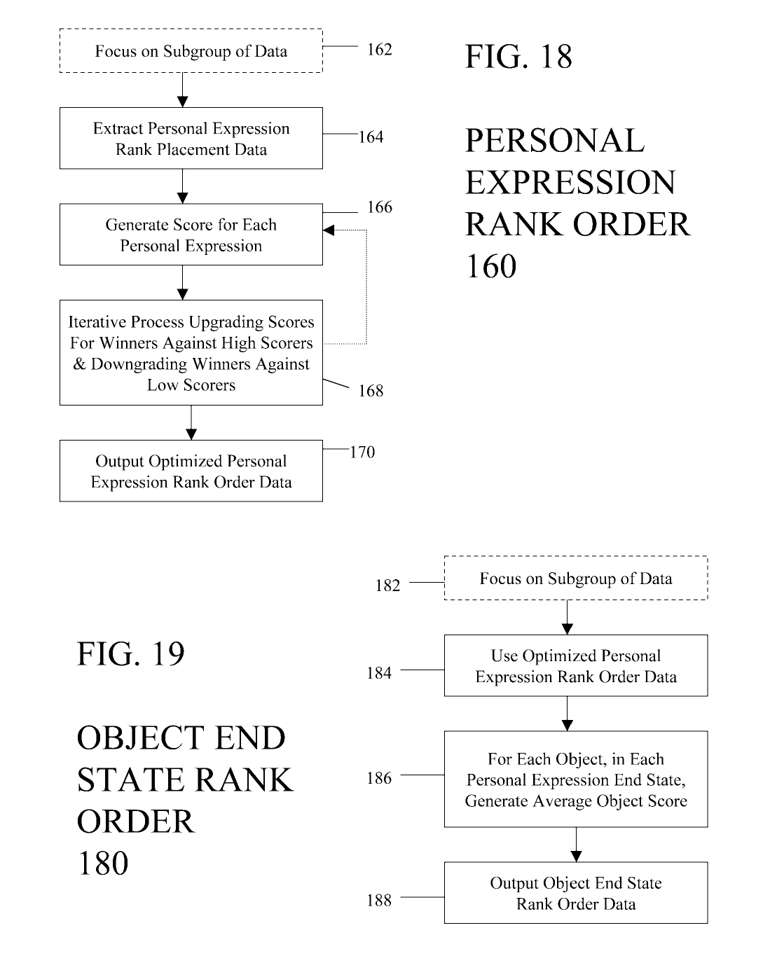

FIG. 18 is an exemplary flow chart representation of personal expression rank order module 160. Element 162 is similar to element 62 discussed with respect to FIG. 13.

According to 164 rank placement data is extracted. This ranking is performed as discussed with respect to FIG. 11 and element 16 of FIG. 1. An alternate or complementary source of rank data may also be extracted from qualitative or quantitative feedback as discussed with respect to element 52 of FIG. 10.

According to 166 a score is generated for each personal expression when using ranking data as discussed with respect to FIG. 11. According to 168 (and back to 166) an iterative process is performed wherein personal expression high scores are reduced for cases where they were ranked against lower ranking personal expressions. Likewise, lower scores are increased for personal expressions that had to compete with the higher-ranking personal expressions. Alternative or additional processes according to 166 and 168 may take place given use of feedback data as discussed with respect to element 52 of FIG. 10.

According to 170 rank order data is outputted that is indicative of user affinities to personal expressions.

FIG. 19 is an exemplary flow chart representation of object end state rank order module 180. The purpose of object end state rank order module 180 is to determine which objects were the primary factors behind particular personal expressions having higher or lower ranks.

Optional element 182 is similar to element 62 discussed with respect to FIG. 13. According to 184 information such as that obtained from the process represented in FIG. 18 is provided.

According to 186 objects from each personal expression end state inherit the average personal expression rank order (as discussed with respect to FIG. 18) of all personal expression end states in which they appear. According to 188 the object rank order data is presented and is available for possible use in other modules.

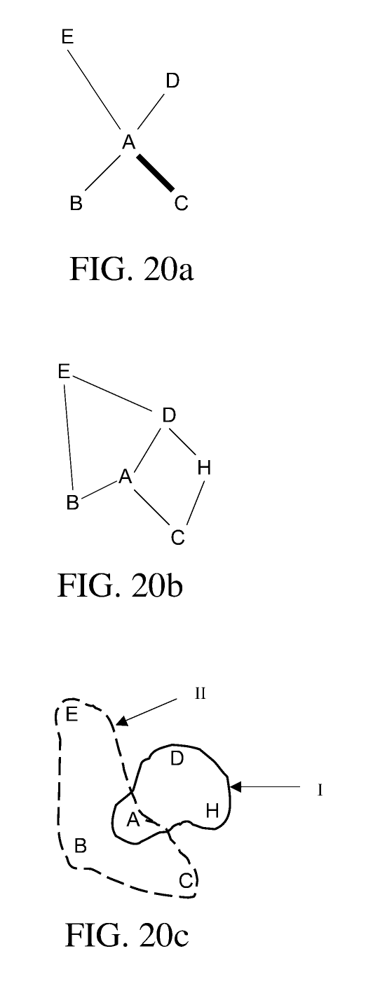

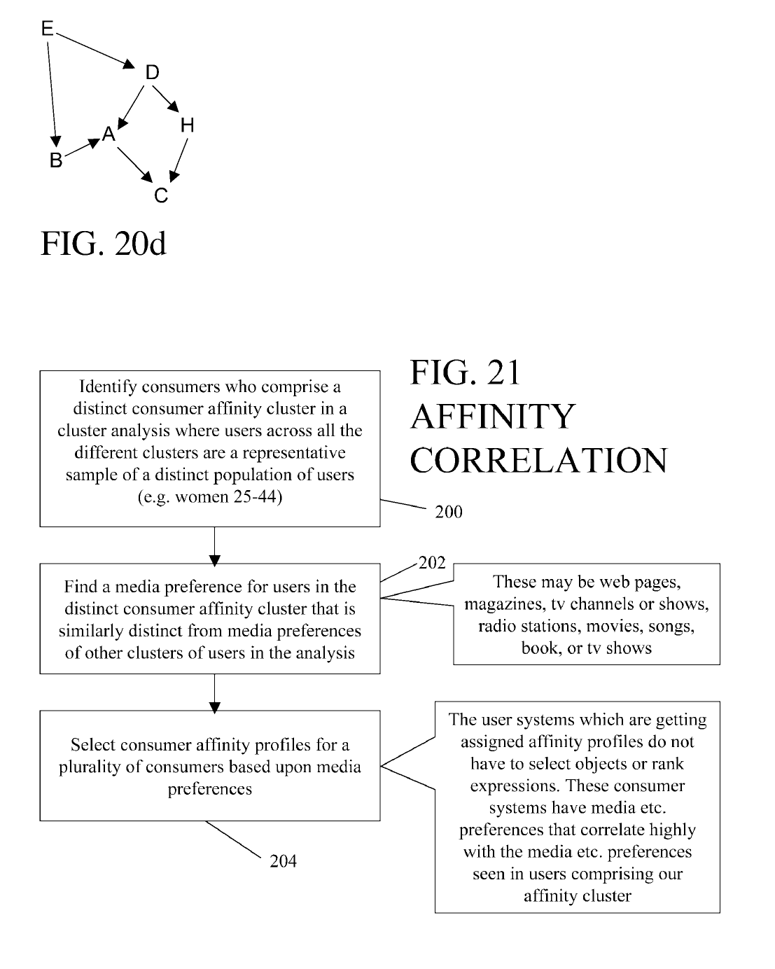

FIGS. 20a-20d are intended to illustrate some exemplary user affinity knowledge that results from processing performed by analytical subsystem 28. As discussed earlier, affinity knowledge can include the meanings and/or emotional responses that a user has for a particular object or sets of objects. FIGS. 20a-20d may be similar to portions of self organizing maps or energy minimized maps discussed with respect to earlier figures.

FIG. 20a is an affinity node map displaying associations to object A. The strength of association can be depicted in various ways including by distance and line weight. In this example, based on proximity, object D has a stronger association with object A than does object E. Based on line weight, object C has the strongest association with object A as compared to the association of either object B, D, or E.

FIG. 20b is an affinity map displaying associations between a set of objects. The position of the objects on the map is representative of the relative strength of association between pairs or sets of objects. For example, in FIG. 20b, objects A and E are both associated with objects B and D. The closer proximity of B and D to object A indicate A has a stronger association with B and D relative to object E. Analytical techniques such as Self Organizing Mapping and Energy Minimized Graphs can be used to generate these maps. Some of these techniques were utilized with respect to the earlier figures.

Note that the type of knowledge displayed in FIGS. 20a, 20b, or similar types of graphical depictions can be utilized to compare and contrast different variables such as different groups or clusters of users. Clusters of users can be compared with a focus on individual objects as in FIG. 20a or to multiple associations between objects as in FIG. 20b. An exemplary method of comparison is to create separate maps for each variable being analyzed, and then juxtapose, switch, or overlay the separate maps.

FIG. 20c depicts knowledge concerning the associations of sets of objects in order to highlight different variables in the analysis. FIG. 20c is not related to FIG. 20a or FIG. 20b. Identifying variables, and generating the position of the objects in the map based upon the combined effect of the variables on inter-object associations generate the Self Organizing Map in FIG. 20c. Variables being analyzed may include defined groups of users, or specific objects within the larger set of objects being analyzed.

Once the map representing the effect of multiple variables has been generated, the effect of each variable in the maps is highlighted in a manner such as the areas denoted I and II. For example, let the position of objects within the maps is determined by the combined associative effects for two demographic groups. The areas labeled I and II show a method of highlighting strong associations for each of the two groups.

According to FIG. 20c, the group labeled I has a strong level of association between objects A, D, and H as described by the solid line. The second group of users labeled 11 has a strong level of association between objects B, C, and E as described by the dotted line.

In another embodiment, the areas in FIG. 20c labeled I and II might represent the associations that result when the map is generated using an analysis that has objects A and B both affecting the placement of the objects in the map. In this example, the solid line would highlight the objects with the strongest relative associations for object A, and the dotted line represents strongest relative associations for object B.

The method of highlighting the affect of a variable might be to enclose an area using a bounding line as shown, or it may use a colored background where the intensity of the color represents the strength of association. When color backgrounds are used, areas of overlap can be made distinct by combining the colors to define a new color. Another approach to highlighting the affect of a variable may include connecting objects using lines of different color for each group. Different line widths or color intensities can be used to convey additional information. Boundaries, background colors, and connecting lines may all be used at the same time to convey multiple levels of information.

FIG. 20d is an affinity map displaying Bayesian relationships between a set of objects. Similar to FIG. 20b, the position of the objects on the map is representative of the relative strength of association between pairs or sets of objects. The arrows connecting the objects identify the Bayesian relationships between the objects or sets of objects. For example, arrows may indicate that a selection of object E tends to precede selection of objects B and D. Object B or D may tend to precede selection of object A.

In FIGS. 20 a-d the objects A, B, C, D, E, etc., can represent users, entire personal expressions, or parts of personal expressions to name a few examples.

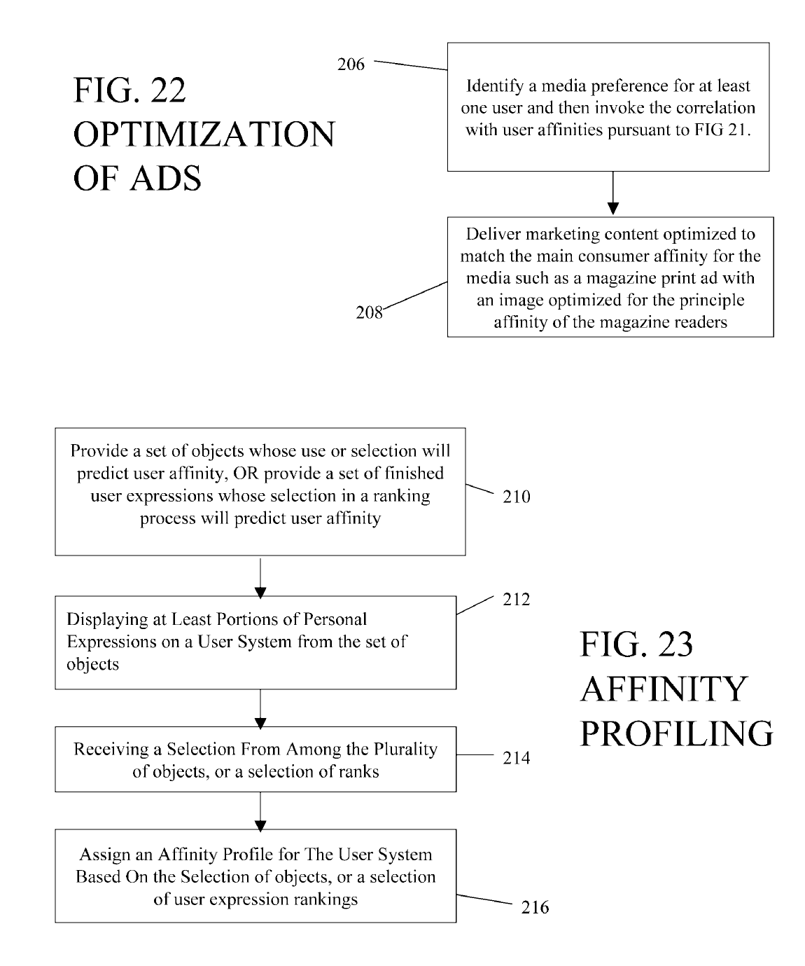

FIGS. 21-27 represent methods by which information developed from the methods described with respect to FIGS. 1-19 can be utilized to optimally generate marketing content, understand clusters of users, or enhance recommendation systems. In the following descriptions, “user affinity information or knowledge” can be any information or knowledge derived from users who have created personal expressions, ranked or evaluated personal expressions, or selected portions of personal expressions. “User affinity profiles” determine what clusters users belong to based upon user affinity knowledge.

FIG. 21 is a process flow representation of an exemplary way in which user affinity information is inferred indirectly from certain media preferences. According to 200 a group of users is identified that is a “distinct user affinity cluster” based upon both user affinity information and a second criteria.

According to 202 a consistent media preference is identified for the distinct user affinity cluster. The media can be web pages, print media, video media, music media, or any combination of the above. A media preference can be indicated by a URL selection or bookmark, a newspaper or magazine subscription, a music or movie selection, a selection of a radio or television broadcast, to name a few.

According to 204, additional users are assigned user affinity profiles based upon media preference criteria. Thus, the additional users are assigned a user affinity profile based upon their preferences for media content by virtue of the correlation established according to 202.

FIG. 22 is a process flow representation of a way of delivering optimized marketing content such as optimized advertisements. According to 206, a media or media channel is assigned a principle affinity profile. This is pursuant to the process depicted in FIG. 21. According to 208 marketing content optimized for the user affinity profile is delivered to the user. The marketing content can be print media, a web-based advertisement, and broadcast content, to name a few examples.

FIG. 23 is a process flow diagram depicting a streamlined way of determining an “affinity profile” for a user when knowledge about particular affinities is known based upon earlier-created personal expressions. According to 210, a set of entire personal expressions, portions of personal expressions, or objects are provided that are strongly correlated to user affinities. The set of objects can be a subset of an original set of objects initially used to establish affinity profiles. The subset of objects can be chosen based on the strength of the objects predictive capacity for an affinity profile. For example, an affinity profile can be established based on user ranking of finished expressions as described in previous figures. Once complete, a subset of expressions may be identified for each affinity profile in a manner such that a user ranking this subset of expressions can be assigned an affinity profile with a high degree of confidence.

According to 212, a plurality of the objects, portions, or expressions from 210 is displayed on a user system. According to 214, information is received from the user system defining a ranking or selection of one or more of the objects, portions, or expressions. According to 216, the “affinity profile” is assigned to the user or user system from which the information is received.

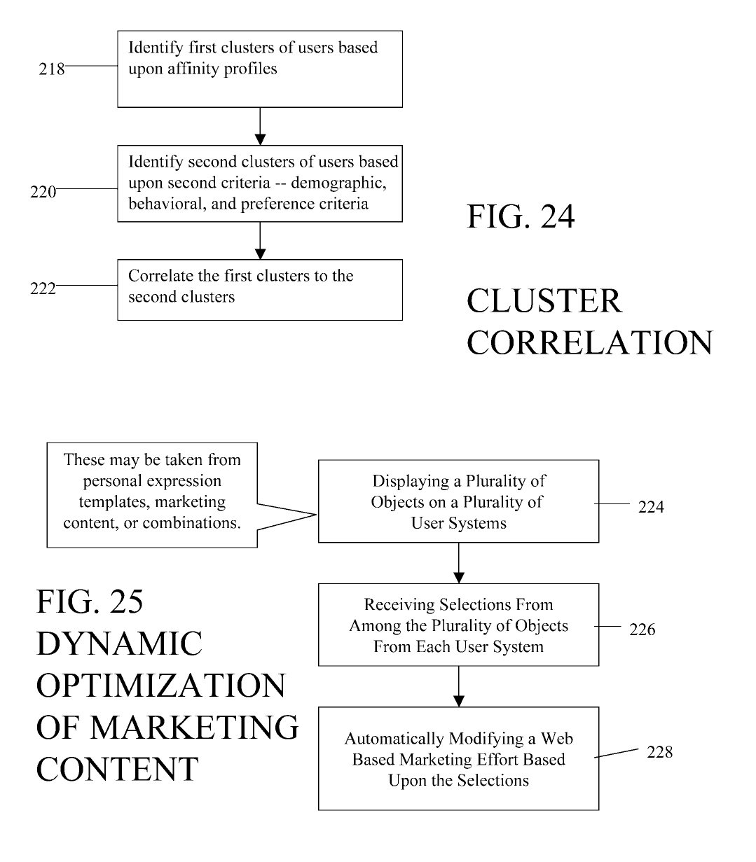

FIG. 24 is a process flow diagram depicting a way of correlating user affinity profiles to other types of profiles such as those based on demographic or behavioral criteria. According to 218 a first cluster of users is identified using affinity profiles obtained using processes described earlier.

According to 220 second cluster of users is identified from the group of users based upon other criteria such as demographics, behavior, or preferences (such as preferences for certain media).

According to 222 a correlation is made between the first and second clusters to relate the other criteria to the user affinity profiles.

FIG. 25 is a process flow diagram depicting a way of automatically optimizing web-based advertisements or marketing content based upon user affinity when the user affinity is determined using objects integrated into the marketing content. The process described may include approaches for a multi-step method of marketing content delivery. For example, an advertising campaign may present a series of personal expressions to a user as part of a game or banner advertisement at a web site. Based on users interaction with the game or banner, such as selecting a favorite personal expression, the advertisement could deliver subsequent marketing content optimized for the affinity profile predicted by the user selection.

According to 224 a plurality of objects are displayed on a number of user systems as part of a marketing effort. The plurality of objects can, for example provide a means for assigning an affinity profile as described in element 210 of FIG. 23.

According to 226 a selection from among the objects is received from each of the user systems. According to 228 a web based marketing effort is automatically modified based upon the selections. Within 228 may be additional processes such as processing the information as discussed with respect to element 10 of FIG. 1.

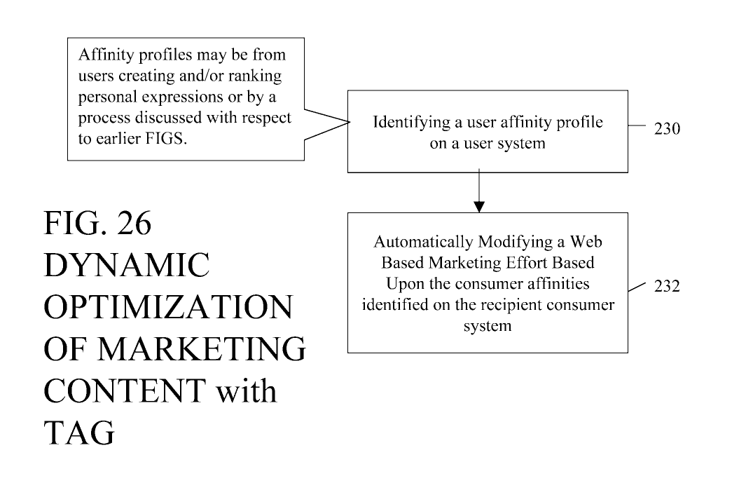

FIG. 26 is a process flow diagram depicting a way of automatically modifying or optimizing web based marketing content based upon a pre-existing affinity profile for a user. This can further be described as targeted marketing based upon a user affinity profile.

According to 230 a user system is assigned a user affinity profile. This may be a result of a previously established identifier or tag (such as a “cookie”) that defined the user affinity profile. According to 232 the profile is utilized to optimize the components of a marketing communication prior to its delivery to the user system.

Note that the affinity profile according to 230 may have been generated according to any methods previously discussed such as the methods discussed with respect to FIG. 1 and/or 23.

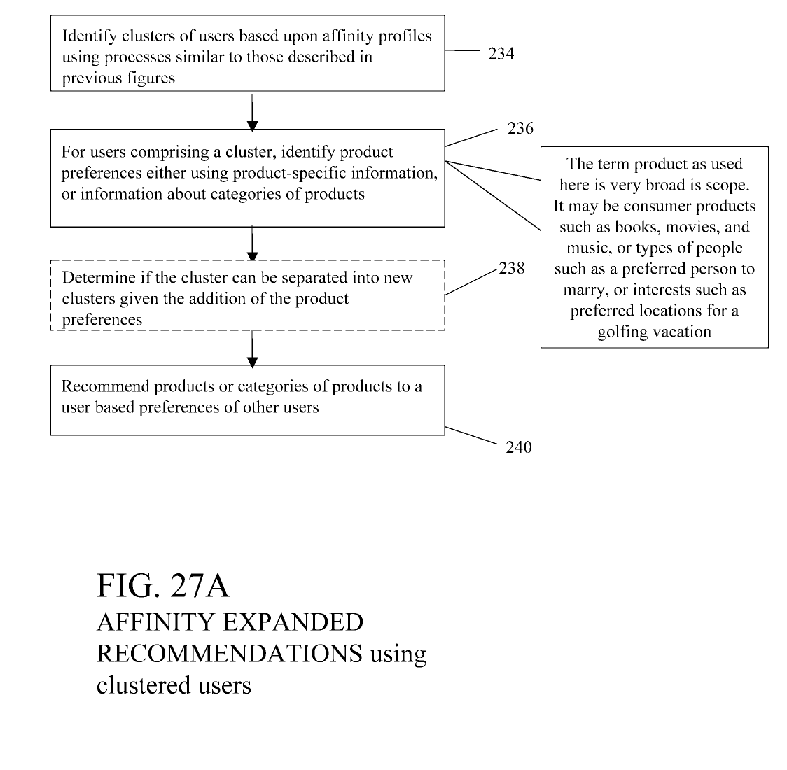

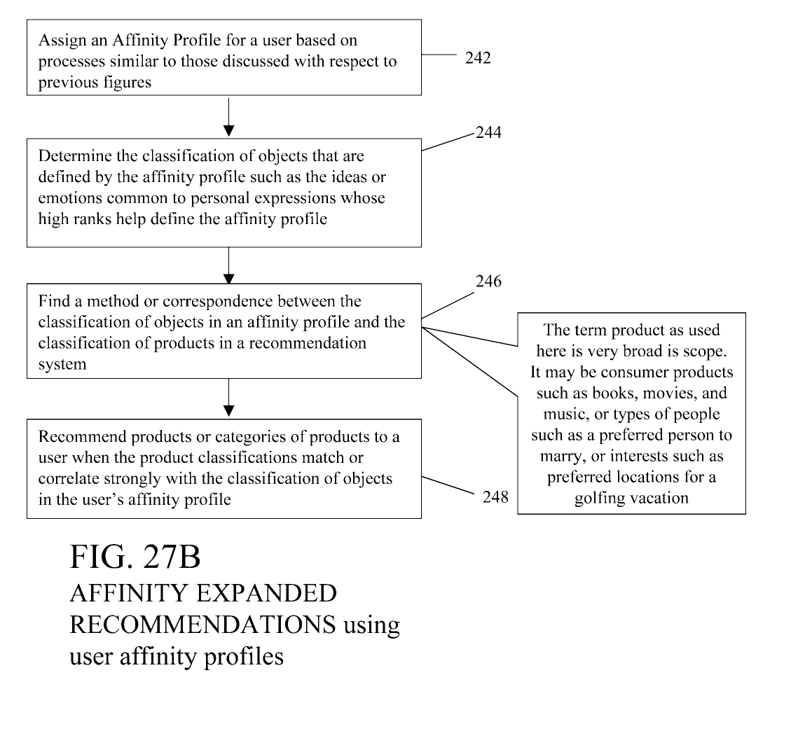

FIG. 27A is a flow chart representation of a way of using affinity profiles to expand recommendation systems using clusters of users. According to 234 clusters of users are identified by finding common affinity profiles. The user affinity profiles are determined using processes that are the same or similar to those discussed earlier.

According to 236 products or categories of products preferred by users within a cluster are identified. According to 238 the new information may be used to further segment the users comprising the affinity profile cluster. This is an optional step.

Finally, according to 240 products for a user in the cluster can be recommended by analyzing what other users in the cluster prefer. One embodiment of an expanded recommendation system is product purchase systems that tell users, “Users who purchased this product also purchased these other products”. These systems would now have the option of telling users, “Users who purchased this product, and who have similar affinities as you also purchased these other products.”

FIG. 27B is a flow chart representation of a way of using classifications within an affinity profile to expand recommendations for users who have an assigned affinity profile. According to 242 a user is assigned an affinity profile. According to 244 the affinity profile is analyzed to determine the classifications of the objects, which are central to the definition of the profile.

According to 246 a method of classifying products within a recommendation system is identified where the classification of products corresponds or can be correlated to the classification of objects in the affinity profile. Finally, according to 248 a recommendation to the user is made for products whose classifications are indicated by the affinity profile assigned to the user.

For example, an affinity profile may identify users who have a preference for personal expressions that fit into the classifications of heroic themes, and celebratory themes. Given a movie recommendation system, which identifies movies according to the primary theme of the movie, the affinity profile information may be used to recommend movies with heroic and/or celebratory themes.

When a user creates or defines a creative expression, the creative expression and/or the sequence of building the creative expression can be utilized to identify an affinity profile for the user. In one embodiment the affinity profile defines what cluster a user falls into. As discussed before, there are other ways of determining an affinity profile for the user such as having the user rank order previously defined creative expressions according to preference.

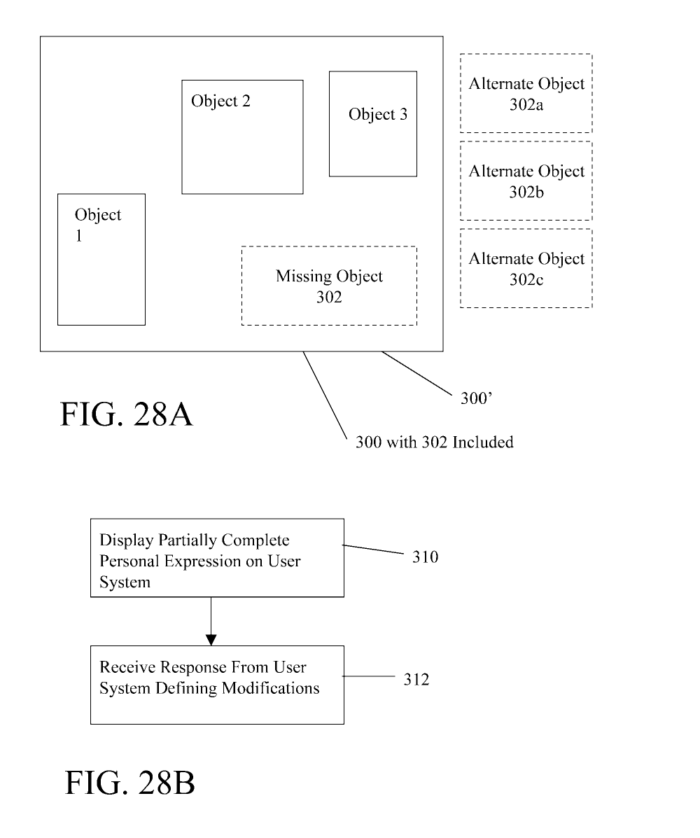

Another way to identify an affinity profile is by “perturbation” which is depicted in FIGS. 28A and 28B. FIG. 28A depicts a partially complete creative expression 300′; containing some objects and having at least one missing object 302, and alternative objects 302a, 302b, and 302c from which a user can choose to complete expression 300′. We will refer to the completed creative expression as creative expression 300. The completion of expression 300′ may be based on the selection of one object as shown, or multiple objects.

The object or objects which a user chooses to create a personalized version of expression 300 will predict which affinity profile or profiles define that user. The selection of the expressions that are highly predictive of user affinities based on completion comes from the analysis of data about how such poems are created by other users, and how user clusters and affinities are determined with this data according to previously stated techniques such as those discussed with respect to FIG. 16.

According to 310 of FIG. 28B, a partially completed creative expression (such as 300′) is displayed upon a user system. According to 312, a response is received from the user system that defines modifications to creative expression 300′. As a result of the method of FIG. 28B, a user profile may be identified for the user. The method of FIG. 28B may have to be done more than once to determine an affinity profile for a user. Also note that other information besides the information obtained as a result of the method of FIG. 28B may be used to determine the profile for a user.

Referring again to FIGS. 28A and 28B, the user may select the original missing objects 302a, 302b, and 302c to complete expression 300′. This object 302 would then be indicative that the user might fit the same profile as those defined by expression 300. One way to assure this is to select an object that tended to have a strong association with a particular cluster of users but a lack of association for users of other clusters.

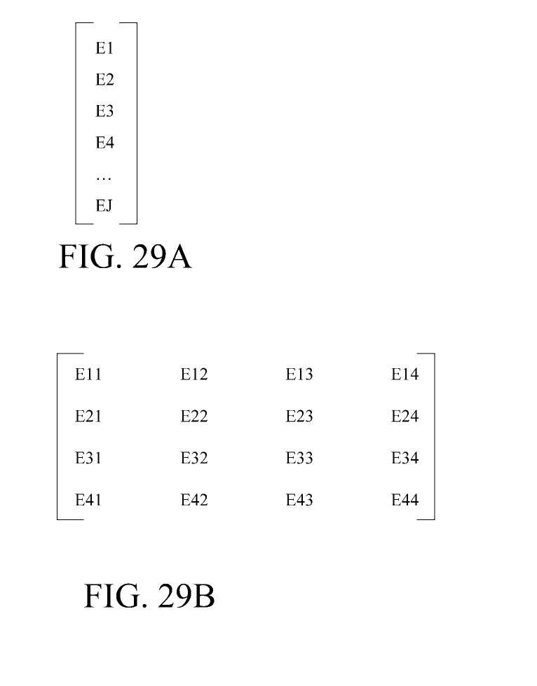

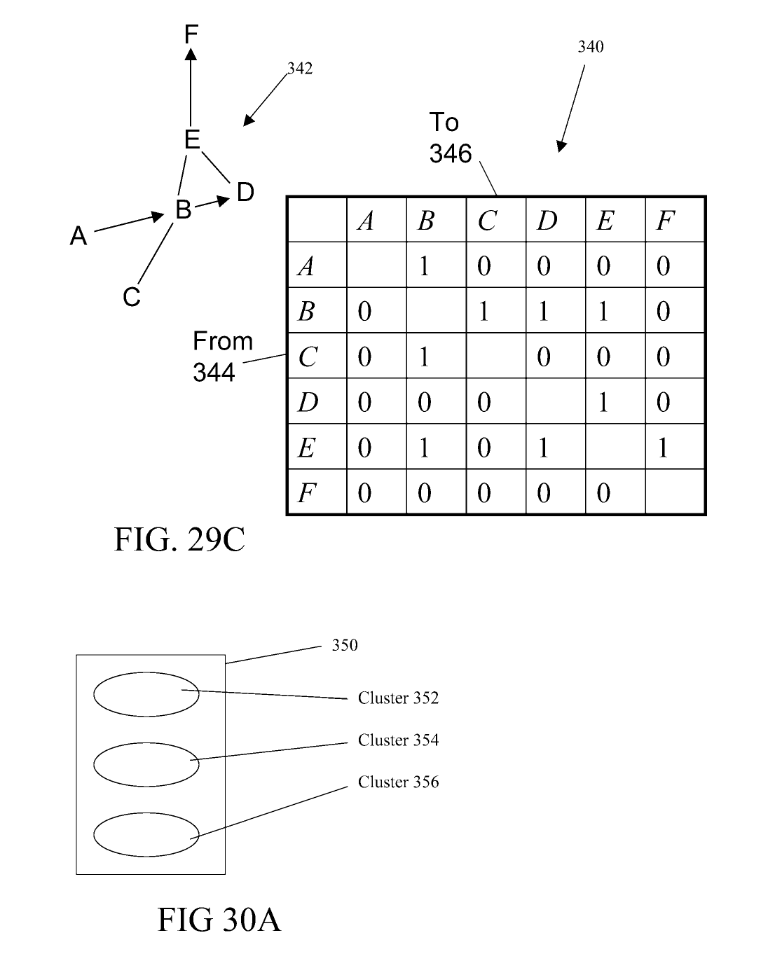

An affinity profile can be based on preferred objects, combinations of objects, creative expressions, etc., as discussed previously. Exemplary ways in which to represent affinity profiles via arrays of parameters in a quantitative manner are depicted according to FIGS. 29A-C. An affinity profile can be at least partially represented as an array having one or more dimensions. Each component of the array may represent a relative affinity for an object, a combination of objects, or an order in which objects are selected.

FIG. 29A is an exemplary vector or one dimensional array representation of an affinity profile. Numbers E1, E2, E3, E4 . . . EJ represent an affinity for objects 1, 2, 3, 4 . . . J respectively. For example each of number EN (for object N) may have a magnitude representing the strength of an affinity that a user has for object N. In the case of an affinity profile each number may represent the centroid of a cluster of users. In one embodiment, negative numbers are utilized to represent a lack of feeling for, or even the dislike of an object.

FIG. 29B is an exemplary matrix representation of an affinity profile. Each number E(I,J) wherein I does not equal J represents the magnitude of a user affinity for selecting first object I and then object J. Each number E(I,J) wherein I=J represents the magnitude of a user affinity for object I.

Note that a matrix for representing an affinity profile can have more than two dimensions. A parameter E(I,J,K) could represent an affinity for selecting object I, then object J, and then object K. If all the permutations have approximately the same number, then there is no preference in the order of selection. If the permutations vary greatly then there is a preference in order of selection.

FIG. 29C depicts a way of relating an affinity matrix or array 340 and an affinity map 342. The array 340 has a “from” column of objects 344 and has a “to” row of objects 346. This affinity matrix is a way of depicting user selection of objects during the creation of a creative expression. The following explains how to interpret the matrix 340 and relate it to map 342:
In matrix 340 the intersection of “from” row A and “to” column B has a value of 1 but the intersection of “from” row B and “to” column A has a zero. This indicates a preference for selecting object A prior to selecting object B. This corresponds to an arrow drawn from A to B in map 342.
The intersection of row B and column C has a value of 1 and the intersection of row C and column B has a value of 1. Since both orders of selection for objects B and C have a 1, this indicates a preference for having B and C selected but no particular order between them. This corresponds to a line segment drawn from B to C in map 342.
In general, when there are pairs of 1's that are symmetrical across the diagonal connecting two objects, this indicates a preferred association for the objects with no particular preference for selection order. Examples depicted in matrix 340 and map 342 includes pairs B & C, B & E, and D & E.
In general, when there is a 1 connecting a “from” object to a “to” object but no symmetrical counterpart, this indicates a preferred association as well as an order. Examples depicted in 340 and map 342 includes pairs B→D, and E→F.

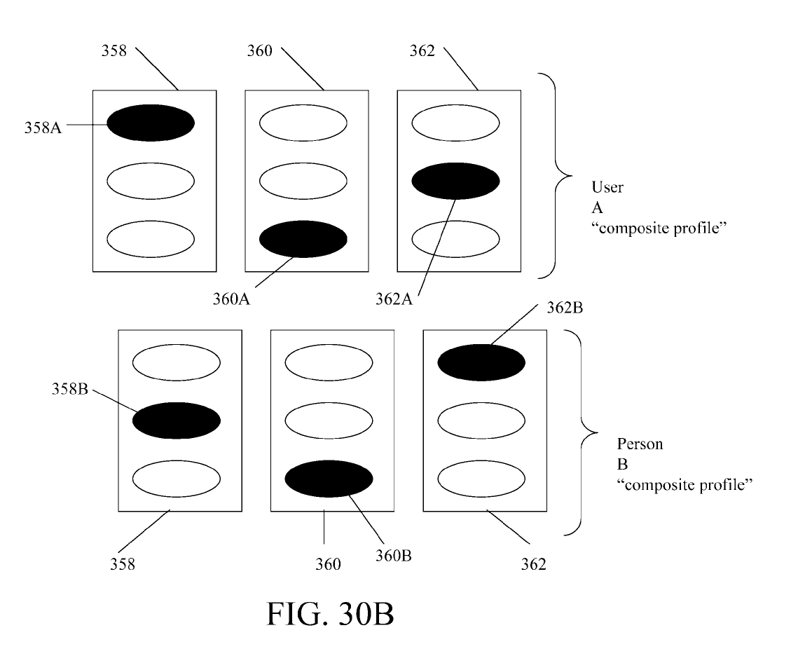

FIGS. 30A and 30B depict “composite” affinity profiles for users. A composite affinity profile is the combination or composite of several individual affinity profiles that are each based on a topic 350. Within topic 350 are several clusters, including cluster 352, cluster 354, and cluster 356. Each cluster defines an affinity profile based upon topic 350 and methods of cluster analysis previous defined such as with respect to FIG. 16.

Topic 350 may be based on a theme, idea, or question. For example a topic may refer to a personal expression template that is based on a certain theme. The personal expression template may be similar to one described with respect to FIG. 5. When a set of users select and place objects to define personal expressions data is gathered. According to this example, based on a user's selections, that user is assigned to one of the three clusters 352-356. The result may have more or fewer clusters depending on the analytical methods (for clustering) and the particular template. In this example, which of the three clusters that a user's efforts and result determine defines the user's affinity profile for theme 350.

If affinity profiles are identified for each user for more than one topic, the result can be as depicted in FIG. 30B; here two users, user A and user B are depicted. For topics 358, 360, and 362, user A has been identified with clusters or affinity profiles as indicated by the darkened ovals (358A, 360A, and 362A). The combination of the affinity profiles or clusters 358A, 358B, and 358C can be thought of as the “composite affinity profile” of user A.

As depicted, user B has been identified with clusters or affinity profiles 358B, 360B, and 362B. Thus, the combination of affinity profiles 358B, 360B, and 362B can be thought of as the “composite affinity profile” of user B. In this example, users A and B have the same affinity profile for topic 360 but they have different affinity profiles for topics 358 and 362.

The number of topics and affinity profiles within a topic can vary greatly from FIG. 30B. The three topics and three clusters were selected for FIGS. 30A and 30B for illustrative simplicity.

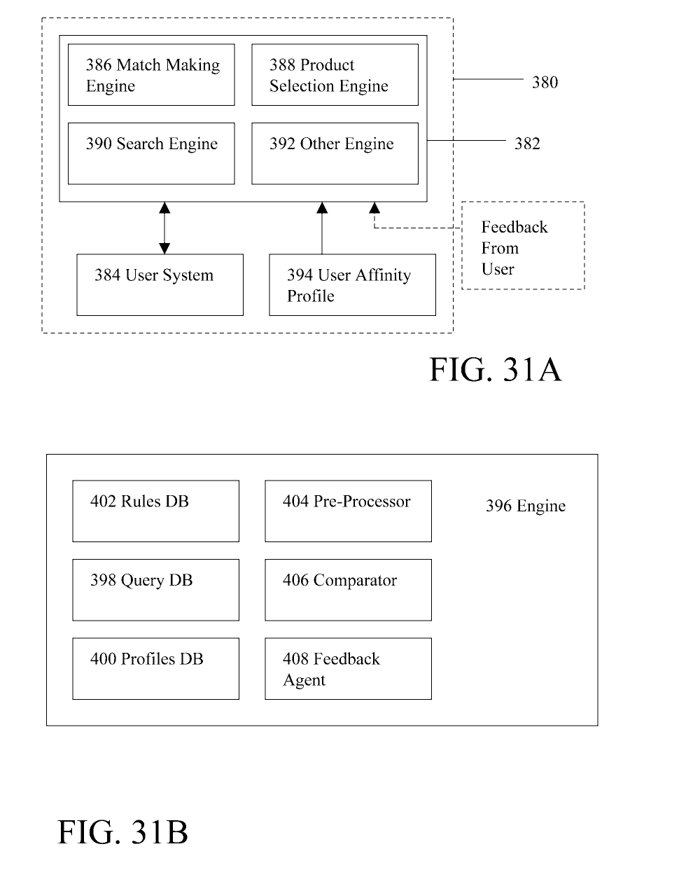

An overall system 380 according to the present invention is depicted in block diagram form in FIG. 31A. Overall system 380 includes a query response system 382 coupled to user system 384.

Query response system 382 includes a number of engines including match making engine 386, product selection engine 388, search engine 390, and any other engine 392 that may respond to queries. Each engine 386-392 within query response system 382 is configured to delivery query results to user system 384 in response to queries from user system 384 and/or from receiving a user affinity profile 394 associated with user system 394. In one embodiment, user affinity profile 394 is a composite affinity profile as discussed with respect to FIG. 30B. In a preferred embodiment, each of the engines 386-392 responds more optimally to a query from user system 384 by utilizing parameters provided as part of user affinity profile 394.

Match making engine 386 is configured to use affinity profile 394 and query information to identify another user who may be a match for the user of system 394. Product recommendation engine 388 is configured to use affinity profile 394 and query information to identify recommended products for the user of system 394. Search engine 390 is configured to use affinity profile 394 and query information to delivery optimized search results for the user of system 394. Optimized search results may be items of interest to the user, and/or advertisements targeted to match the user's search request and affinity profiles. In one embodiment of advertising, search engine 390 may use the user affinity profile 394 to include words or graphics that serve to increase user response to an advertisement presented in the search results.

An exemplary engine 396, which may be one of engines 386-392, is depicted in block diagram form in FIG. 31B. Within engine 396 are databases 398-402. Query database 398 stores information defining how engine 396 responds to a query. Profiles database 400 stores information defining profiles or clusters of users within various topics. Rules database 402 stores information defining how a query is modified by the input of an affinity profile 394.

Engine 396 also includes software modules 404-408. Preprocessor 404 is configured to parse an incoming query and to modify the query according to parameters associated with affinity profile 394. Comparator 406 performs a comparison of affinity profile 394 relative to affinity profiles stored in profile database 400. In operation, preprocessor and/or comparator 406 may utilize rules database 402 to determine how the response to the query is to be modified based upon affinity profile 394. Feedback agent 408 is configured to obtain user feedback relative to the query results. Feedback agent 408 may be configured to automatically update rules (defined in database 402) to provide more optimal query results.

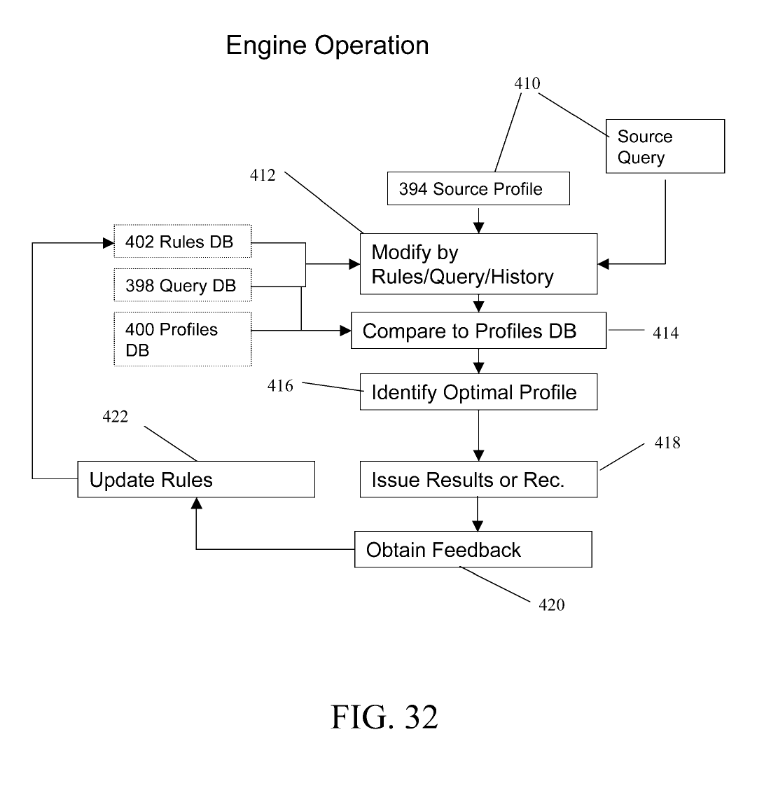

Operation of engine 396 is depicted via process flow diagram in FIG. 32. According to 410, engine 396 receives a query and a source profile 394 from user system 384. According to 412, preprocessor 404 modifies the query using the source profile 394. Step 412 is performed according to rules database 402.

According to 414, the source profile 394 is compared to profiles stored in the profiles database 400. This may be done to find either a matching or an optimal complementary profile according to 416. According to 418, engine 396 displays query results or a recommendation to user system 384.

According to 420 system 380 receives feedback from user system 384 indicative of the effectiveness of the query results. According to 422, the rules database 402 is updated pursuant to the feedback received in step 420.

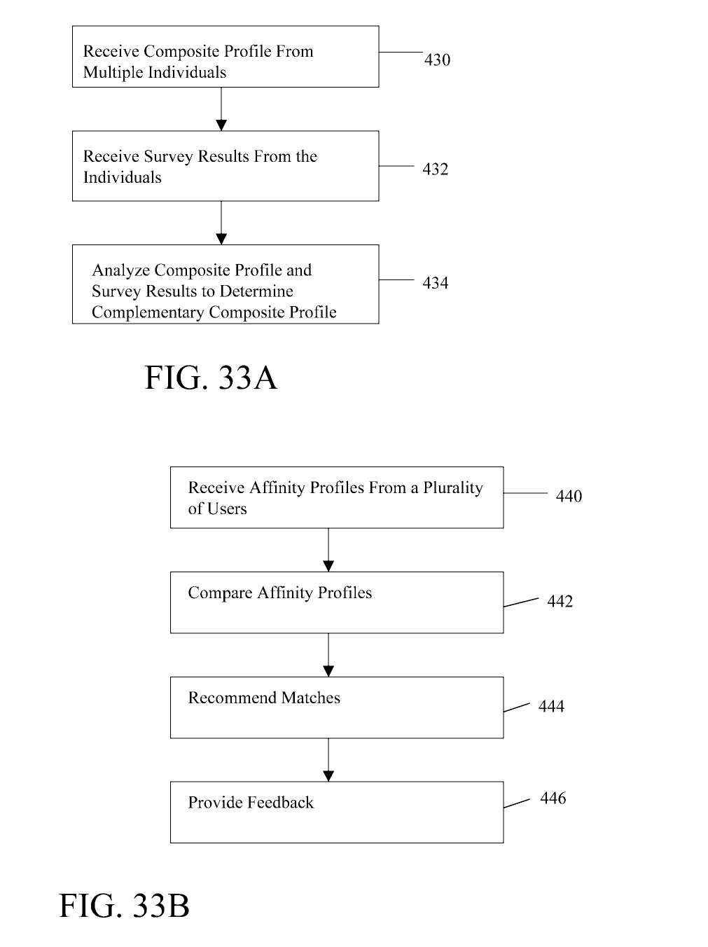

FIGS. 33A and 33B pertain to the operation of exemplary matchmaking engines 386 of the present invention. FIG. 33A depicts a manner in which matchmaking survey results between complementary individuals can be correlated with affinity profiles. According to 430, affinity profiles are received from each of a plurality individuals. According to 432 matchmaking survey results are received from each of the plurality of individuals. According to 434, the survey results and affinity profiles are analyzed to determine complementary pairs of affinity profiles. In a preferred embodiment, the affinity profiles used according to FIG. 33A are composite affinity profiles.

FIG. 33B depicts operation of matchmaking engine 386. According to 440, matchmaking engine receives and stores affinity profiles (which may be composite affinity profiles) from a number of users. They can be stored in profiles database 400. In one embodiment, the matchmaking engine 386 also stores survey results for the users.

According to 442, matchmaking engine 386 compares affinity profiles from a number of users using comparator 406. According to 444, matchmaking engine recommends matches between users. This may be based on affinity profiles that most closely match, or it may be based on affinity profiles known to be complementary.

In a preferred embodiment, 444 is performed using a combination of affinity profiles and survey results. The affinity profiles provide deeper insight for comparing individuals than would be obtained from survey results alone.

In one embodiment, the matchmaking engine 386 has a rules database that defines how to optimize pairs of (composite) affinity profiles. According to 446, survey results are used to provide feedback to the rules database in a manner similar to process 420 of FIG. 32.

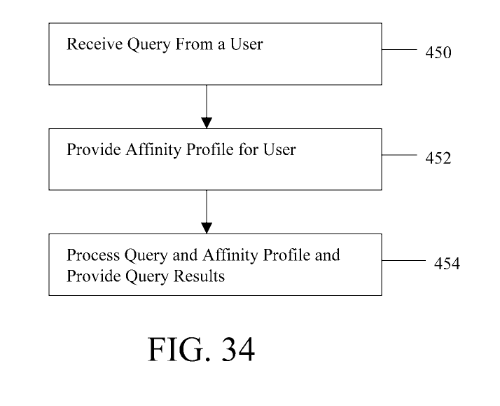

FIG. 34 depicts a way that a query is optimized using an affinity profile. According to 450, system 380 receives a query from user system 384. The query can either be a search query or a product recommendation query.

According to 452, an affinity profile is provided for a user to system 380. According to 454, system 380 processes the query and the affinity profile and defines search results. Also according to 454, the search results are displayed upon the user system.

In a preferred embodiment, the displayed search results include search-related advertisements that are optimized based upon the affinity profile. In one embodiment, objects or combinations used in the advertisement are the same or similar to objects for which the affinity profile indicates a strong affinity.

What we claim is:

1. A method of delivering a product recommendation to a user comprising: providing a correlation between an affinity profile and a product preference for the user, wherein the affinity profile is defined by at least one personal expression; identifying one or more users who fit the affinity profile; and providing product recommendations to the one or more users based upon the correlation.

2. The method of 1 further comprising defining sub-groups of users within the affinity profile and wherein the product recommendations are based upon the sub-groups.

3. The method of claim 1 further comprising identifying a behavior for the one or more users and wherein the product recommendations are based upon the behavior.

4. The method of claim 3 wherein the behavior is a search request or media preference.

5. A software module configured to perform the method of claim 1.

6. A method of delivering targeted marketing content comprising: providing a correlation between a user affinity profile and a second characteristic that has a strong correlation to the user affinity profile; identifying the second characteristic in one or more users; and delivering marketing content to the one or more users based upon the user affinity profile.

7. The method of claim 6 wherein the second characteristic is a particular media preference.

8. The method of claim 7 wherein the media preference is indicated by one or more of media selection, URL visits, URL bookmarks, magazine subscriptions, preferred television or radio programming, newspaper subscriptions, music selections, and movie selections.

9. The method of claim 6 wherein the second characteristic is selected from criteria consisting of one or more of a demographic criteria, a behavioral characteristic, and a user preference.

10. The method of claim 6 wherein the marketing content is one or more of printed media, broadcast media, and web-generated media.

11. The method of claim 6 wherein the second characteristic is derived from one or more product or search requests.

12. A software module configured to perform the method of claim 6.

13. A method of optimizing marketing content for a user comprising: providing information defining a user affinity profile for a user system associated with the user wherein the user affinity profile is based on at least one personal expression; and delivering marketing content to the user based upon the user affinity profile.

14. The method of claim 13 wherein the user affinity profile information is provided by a previously established identifier that is associated with the user system.

15. The method of claim 14 wherein the previously established identifier is a cookie stored upon the user system.

16. The method of claim 13 wherein the marketing content is web-based marketing content that is delivered to the user by displaying the content upon the user system.

17. The method of claim 13 further comprising generating marketing content based at least in part upon the user affinity profile.

18. The method of claim 13 wherein the marketing content is print media content.

19. The method of claim 13 wherein the marketing content is broadcast media.

20. A software module configured to perform the method of claim 13.

21. A method of recommending products comprising: providing a correlation between a category of a product recommendation system and an aspect of a user affinity profile; receiving information from a user system indicative of the aspect of the user affinity profile; and displaying a product recommendation on the user system based upon the information.

22. The method of 21 wherein the aspect of the user affinity profile is an object that at least partially defines the user affinity profile.

23. The method of 21 wherein the aspect of the user affinity profile is an association with one or more objects that partially defines the user affinity profile.

24. A software module configured to perform the method of claim 21.
